(19) United States
(12) Patent Application Publication
(10) Pub. No.: US 2022/0389175 A1
(43) Pub. Date: Dec. 8, 2022

(54) THERMOPLASTIC COMPOSITE MATERIALS

(71) Applicant: BarrFlexTU, LLC, Millbury, MA (US)

(72) Inventors: Ronald L. Fisher, JR., Millbury, MA (US); Matthew W. Perrone, Millbury, MA (US); Mathieu Y. Capelot, Millbury, MA (US)

(73) Assignee: BarrFlexTU, LLC, Millbury, MA (US)

(21) Appl. No.: 17/831,728

(22) Filed: Jun. 3, 2022

Related U.S. Application Data
(60) Provisional application No. 63/196,270, filed on Jun. 3, 2021.

(51) Int. Cl. C08J 5/04; C08J 5/10; C08K 7/06; F16L 11/08; B32B 1/08; B32B 27/20; B32B 27/30

(52) U.S. Cl. CPC C08J 5/042; C08J 5/10; C08K 7/06; F16L 11/08; B32B 1/08; B32B 27/20; B32B 27/304; C08J 2327/16; C08J 2323/08; C08K 2201/004; C08K 2201/003; B32B 2262/106; B32B 2597/00

(57) ABSTRACT

Composite materials are described herein. The composite materials include a polymer matrix comprising at least one fluorinated homo- or copolymer and continuous fibers dispersed within the polymer matrix. The continuous fibers are present within the composite material in an amount between about 10 wt % and about 90 wt % of a weight of the composite material. The composite materials also include a filler dispersed within the polymer matrix. The filler is present within the composite material in an amount between about 5 wt % and about 25 wt % of an amount of the polymer matrix.

### CROSS-REFERENCE TO RELATED APPLICATIONS

The present application claims the benefit of U.S. Provisional Patent Application No. 63/196,270 entitled Thermoplastic Composite Materials filed on Jun. 3, 2021, the entire contents of which are incorporated by reference herein.

### TECHNICAL FIELD

This disclosure relates generally to thermoplastic composite materials and methods of forming thermoplastic composite materials, and, more specifically, to thermoplastic composite materials and methods of forming thermoplastic composite materials with improved mechanical properties.

### BACKGROUND

There is a growing interest in the use of thermoplastic composite materials in more rigorous applications than they are traditionally used where previous generations of thermoplastic composite materials could not meet performance requirements.

For instance, thermoplastic composite materials generally, and polyvinylidene fluoride (PVDF) specifically, have been used for several decades as liners (i.e. internal layer) in flexible pipes in the oil and gas industry. These pipes typically comprised several layers of metal structures that bring mechanical resistance to the pipe both by increasing resistance to tensile stress and increasing pressure resistance.

In the past several years, there has been a trend to replace piping with several metal layers with piping made of primarily composite materials. For example, PCT Publication No. WO1999067561 describes a pipe structure having an inner liner of thermoplastic material, an intermediate reinforced, polymer, multi-layer component and an outer thermoplastic liner.

In the oil and gas industry, these new composite materials for use in flexible pipes often include a combination of PVDF and continuous carbon fibers and are commonly produced using technologies such as automated tape placement (ATP). During an automated tape placement process, a “thin” tape (i.e. typically 100-300 μm) consisting of a composite material (e.g. having both a thermoplastic matrix and carbon fibers disposed therein) is laid on top of a liner material to obtain a multi-layer composite material. A heating system (e.g. a laser, infrared heat, etc.) maybe used to locally melt the thermoplastic matrix in the tape, thus permitting the adhesion between the different layers.

Some have reported that arranging carbon fibers to be unidirectional within the thermoplastic matrix has resulted in the formation of tapes with superior tensile strength, which is an important property for flexible pipes such as flowlines, risers, jumpers and TCPs being used in the oil and gas industry.

In some specific applications within the oil and gas industry, such as but not limited to off-shore production, it is important for tapes to have both superior compression strength and superior tensile strength. For instance, superior compression strength and superior tensile strength can be important mechanical properties when a pipe is placed on a coil and/or reel. As pipes bend, one portion of the pipe extends and an opposed portion of the pipe compresses. Higher compressive strength is important for composite pipe especially for larger diameters. It allows reeling adequate lengths for an off-shore installation for example without significant pipe property reduction or deformation of the pipe that can occur if the compressive strength is exceeded. Thus, an improved compressive strength can enable effective employment of an all thermoplastic composite pipe that might otherwise not be possible. This results in a pipe that is stable during initial reeling, storage and then in use.

Superior tensile strength in thermoplastic composite materials is commonly obtained by increasing the fiber content of the thermoplastic composite material and/or increasing the tensile strength of the fibers embedded in the matrix of the thermoplastic composite material. On the other hand, mechanisms to achieve superior compression strength especially in unidirectional high strength thermoplastic composite materials are not well understood. It is unclear how fiber loading, fiber-matrix adhesion, alignment of fibers, matrix properties, and other properties impact compressive strength of thermoplastic composites.

Accordingly, there is a need for thermoplastic composite materials with improved mechanical properties, and specifically for improved thermoplastic composite materials that offer superior tensile strength provided by continuous fibers and superior compression strength.

### SUMMARY

In accordance with a broad aspect, a composite material is described herein. The composite material includes a polymer matrix comprising at least one homo- or copolymer and continuous fibers dispersed within the polymer matrix, the continuous fibers being present within the composite material in an amount between about 10 wt % and about 90 wt % of a weight of the composite material. The composite material also includes a filler dispersed within the polymer matrix, the filler being present within the composite material in an amount between about 5 wt % and about 25 wt % of an amount of the polymer matrix.

In at least one embodiment, the fillers are milled fibers.

In at least one embodiment, the fillers are milled carbon fibers.

In at least one embodiment, the milled carbon fibers have a length less than about 1 mm.

In at least one embodiment, the milled carbon fibers have a length less than about 650 μm.

In at least one embodiment, the milled carbon fibers have a length less than about 150 μm.

In at least one embodiment, the milled carbon fibers have a length in a range of about in a range of about 25 μm to about 100 μm.

In at least one embodiment, the milled carbon fibers have a length in a range of about 80 μm to about 100 μm.

In at least one embodiment, the milled carbon fibers have a diameter in a range of about 5 μm to about 15 μm.

In at least one embodiment, the milled carbon fibers have a diameter of about 7 μm.

In at least one embodiment, the milled carbon fibers have a carbon content between about 92 wt % and about 94 wt %.

In at least one embodiment, the filler is present within the composite material in an amount between about 3 wt % and about 10 wt % of the weight of the composite material.

In at least one embodiment, the filler is present within the composite material in an amount of about 5 wt % of the weight of the composite material.

In at least one embodiment, the continuous fibers are present within the composite material in an amount between about 25 wt % and about 75 wt % of the weight of the composite material.

In at least one embodiment, the continuous fibers are present within the composite material in an amount between about 40 wt % and about 60 wt % of the weight of the composite material.

In at least one embodiment, the continuous fibers are unidirectional.

In at least one embodiment, the composite material includes a polymer matrix comprising at least one fluorinated homo- or copolymer.

In at least one embodiment, the composite material is formed into a thermoplastic tape.

In at least one embodiment, the composite material is used in the oil and gas industry.

In at least one embodiment, the polymer matrix comprises a PVDF homopolymer or copolymer that may optionally contain a portion that comprises PVDF grafted with or copolymerized with a polar carboxylic function monomer.

In at least one embodiment, the polymer matrix comprises a fluoro copolymer with tetrafluoroethylene such as ETFE or ECTFE.

In accordance with another broad aspect, a multilayer structure is described herein. The multilayer structure includes at least one layer including a composite material according to at least one of the embodiments described herein.

According to at least one embodiment of the multilayer structure, the multilayer structure is a multilayer pipe. A multilayer pipe could for example comprise an inner thermoplastic barrier layer bonded to one or more layers of a thermoplastic composite according to at least one embodiment described herein, the one or more layers of thermoplastic composite being covered by additional thermoplastic layers or additional reinforcements and a thermoplastic jacketing layer.

These and other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### DETAILED DESCRIPTION

Various apparatuses, methods and compositions are described below to provide an example of at least one embodiment of the claimed subject matter. No embodiment described below limits any claimed subject matter and any claimed subject matter may cover apparatuses and methods that differ from those described below. The claimed subject matter are not limited to apparatuses, methods and compositions having all of the features of any one apparatus, method or composition described below or to features common to multiple or all of the apparatuses, methods or compositions described below. It is possible that an apparatus, method or composition described below is not an embodiment of any claimed subject matter. Any subject matter that is disclosed in an apparatus, method or composition described herein that is not claimed in this document may be the subject matter of another protective instrument, for example, a continuing patent application, and the applicant(s), inventor(s) and/or owner(s) do not intend to abandon, disclaim, or dedicate to the public any such invention by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

It should be noted that terms of degree such as “substantially”, “about” and “approximately” as used herein mean a reasonable amount of deviation of the modified term such that the result is not significantly changed. These terms of degree should be construed as including a deviation of the modified term, such as 1%, 2%, 5%, or 10%, for example, if this deviation does not negate the meaning of the term it modifies.

Furthermore, the recitation of any numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation up to a certain amount of the number to which reference is being made, such as 1%, 2%, 5%, or 10%, for example, if the end result is not significantly changed.

It should also be noted that, as used herein, the wording “and/or” is intended to represent an inclusive - or. That is, “X and/or Y” is intended to mean X, Y or X and Y, for example. As a further example, “X, Y, and/or Z” is intended to mean X or Y or Z or any combination thereof. Also, the expression of A, B and C means various combinations including A; B; C; A and B; A and C; B and C; or A, B and C.

The following description is not intended to limit or define any claimed or as yet unclaimed subject matter. Subject matter that may be claimed may reside in any combination or sub-combination of the elements or method steps disclosed in any part of this document including its claims and figures. Accordingly, it will be appreciated by a person skilled in the art that an apparatus, system or method disclosed in accordance with the teachings herein may embody any one or more of the features contained herein and that the features may be used in any particular combination or sub-combination that is physically feasible and realizable for its intended purpose.

Herein, the term “thermoplastic” refers to a material, usually a plastic polymer, that becomes softer when it is heated and harder when cooled. Thermoplastic materials can be cooled and heated several times without any change in their chemical or mechanical properties. When thermoplastic materials are heated to their melting point, they melt to a liquid. When thermoplastic materials are cooled below their glass transition temperature, they freeze to a glassy state.

Herein, the term “milled fibers” refers to fibers that are the products of subjecting uniform conventionally available fibers (e.g. polymeric fibers, inorganic fibers, carbon fibers, etc.) to a milling process. For example, the milling process may be accomplished using a hammermill that includes a rotating assembly of hammers and an outer screen, where the uniform fibers (e.g. polymeric fibers that are the product of an extrusion process) are subjected to milling by spinning hammers that shred the fibers until they are broken down to a point where they pass through the outer screen and out of the mill. However, any mill may be used wherein, during the milling process, the uniformity of the commercial fibers is destroyed, and a milled fiber product is produced that features fibers with a variety of lengths. The lengths of the milled fiber product will generally depend upon the starting length of the uniform fibers and the amount of time spent milling the uniform fibers. Specifically, the longer that the fibers are milled, the larger the percentage of fibers having a length shorter than the original fiber length will be. Additionally, the average length of the fibers will decrease as the time spent milling the fibers is increased. Herein, the milled fibers have an average length in a range of about 50 μm to about 150 μm, or an average length in a range of about 80 μm to about 100 μm, or an average length in a range of about 100 μm. The term “milled fibers” as used herein is contrary to the term “chopped fibers” which typically refers to fibers having an average length of about 600 μm.

Recently, there has been a growing interest in developing new and/or improved composite materials and methods of forming composite materials with improved mechanical properties, and specifically for new and/or improved composite materials and methods of forming composite materials that offer superior tensile strength provided by continuous fibers and superior compression strength.

Herein, composite materials and methods of forming composite materials are described. The composite materials are thermoplastic composite materials that include a polymer matrix, continuous fibers dispersed within the polymer matrix and one or more fillers dispersed within the polymer matrix. Herein, the term polymer matrix is intended to refer to the polymer itself as well as any additives that may have been added to the polymer.

In at least one embodiment, the thermoplastic composite materials described herein can be formed into a tape appropriate for use in multilayer products. In some embodiments, these multilayer products may be used in the oil and gas industry. For instance, the thermoplastic composite materials described herein may be used multilayer pipes and multilayer piping equipment used in the oil and gas industry.

### Polymer Matrix

In at least one embodiment described herein, the polymer matrix of the thermoplastic composite materials described herein comprises a polymer matrix having one or more of the following polymers forming a majority of the polymer matrix: fluorinated polymers, nylons, polyaryletherketone (PAEK), polyphenylene sulfide (PPS), polyetherimide (PEI), polycarbonate (PC) or a mixture thereof. When fluorinated polymers are used, fluorinated polymers may include ethylene tetrafluoroethylene (ETFE), ethylene chlorotrifluoroethylene (ECTFE), or polyvinylidene fluoride (PVDF) or a copolymer of vinylidene fluoride and of at least one other co-monomer such as but not limited to: vinyl fluoride, trifluoroethene, chlorotrifluoroethylene, 1,2-difluoroethylene, tetrafluoroethylene, hexafluoropropylene, perfluoro(methylvinyl)ether, perfluoro(ethylvinyl)ether and perfluoro(propylvinyl)ether, wherein the vinylidene fluoride represents at least 75% by weight or a mixture thereof.

In at least one embodiment described herein, when the polymer matrix includes a fluorinated polymer, the fluorinated polymer comprises a fluorinated thermoplastic polymer grafted or copolymerized with a polar carboxylic function. Said polar carboxylic function can be borne by at least one polar monomer selected from the group consisting of: unsaturated monocarboxylic and dicarboxylic acids having from 2 to 20 carbon atoms, acrylic acid, methacrylic acid, maleic acid, fumaric acid, itaconic acid, citraconic acid, allylsuccinic acid, cyclohex-4-ene-1.2-dicarboxylic acid, 4-methylcyclohex-4-ene-1.2 dicarboxylic acid, bicyclo(2,2,1)hept-5-ene-2,3 dicarboxylic acid and undecylenic acid and the anhydrides thereof.

In at least one embodiment, the polymer matrix of the thermoplastic composite materials described herein may comprise other additives such as but not limited surfactants, anti-oxidants, flame retardants, other polymers and the like. In at least one embodiment, the other additives maybe included to the polymer matrix to provide the polymer matrix with selected properties, such as but not limited to promote wetting, increase bond strength, fire protection or the like.

In at least one embodiment described herein, the polymer matrix is PVDF.

In at least one embodiment described herein, the polymer matrix is PVDF sold under the brand name Kynar® PVDF by Arkema S. A. (Colombes, France).

In at least one embodiment described herein, the polymer matrix is present within the composite material in an amount between about 40 wt % and about 60 wt % of the weight of the composite material, or in an amount between about 40 wt % and about 50 wt % of the weight of the composite material, or in an amount of about 50 wt % of the weight of the composite material or in an amount of about 45 wt % of the weight of the composite material.

### Continuous Fibers

As noted above, the composite materials described herein include continuous fibers dispersed within the polymer matrix.

The continuous fibers of the composite materials described herein may be chosen from the group consisting of: carbon fibers; silica fibers, glass fibers, E type glass, R type glass, S2 type glass; boron fibers; ceramic fibers, silicon carbide, boron carbide, boron carbonitride, silicon nitride, boron nitride; basalt fibers; fibers or filaments based on metals and alloys thereof; fibers based on metal oxides; natural fibers, flax, hemp and sisal fibers; metallized carbon fibers and metallized glass fibers and mixtures thereof.

In at least one embodiment described herein, the continuous fibers are carbon fibers.

In at least one embodiment, the continuous fibers are high-strength carbon fibers. For instance, the high-strength carbon fibers may have a tensile strength in a range of about 500 ksi to about 1000 ksi, or in a range of about 600 ksi to about 800 ksi, or of about 700 ksi.

In at least one embodiment, the continuous fibers are standard-modulus carbon fibers. For instance, the standard-modulus carbon fibers may have a tensile modulus in a range of about 30 to about 40 Msi, or a tensile modulus in a range of about 32 to about 35 Msi, or in a range of about 33 to about 34 Msi.

In at least one embodiment, the continuous fibers are high-strength, standard modulus carbon fibers.

In at least one embodiment described herein, the continuous fibers are unidirectional.

In at least one embodiment described herein, the continuous fibers are present within the composite material in an amount between about 10% and about 90% of the weight of the composite material, or in an amount between about 25 wt % and about 75 wt % of the weight of the composite material, or in an amount between about 40 wt % and about 60 wt % of the weight of the composite material, or in an amount between about 40 wt % and about 50 wt % of the weight of the composite material, or in an amount of about 50 wt % of the weight of the composite material or in an amount of about 45 wt % of the weight of the composite material.

### Fillers

As noted above, the composite materials described herein include one or more fillers dispersed within the polymer matrix.

In at least one embodiment described herein, the one or more fillers comprises a material selected from: carbon fibers; silica fibers; glass fibers; E type glass; R type glass; S2 type glass; boron fibers; ceramic fibers; silicon carbide; boron carbide; boron carbonitride; silicon nitride; boron nitride; basalt fibers; fibers or filaments based on metals and alloys thereof; fibers based on metal oxides; natural fibers; flax; hemp and sisal fibers; metallized carbon fibers and metallized glass fibers and mixtures thereof.

In at least one embodiment, the one or more fillers may comprise non-fiber fillers, such as but not limited to carbon black, silica beads, ceramic beads and the like.

In at least one embodiment described herein, the one or more fillers comprises milled fibers. The milled fibers may be of a material selected from the list of materials provided above.

In at least one embodiment described herein, the one or more fillers comprises chopped fibers. The chopped fibers may be of a material selected from the list of materials provided above.

In at least one embodiment described herein, the one or more fillers comprises a carbon fiber filler, such as but not limited to chopped carbon fibers or milled carbon fibers.

In at least one embodiment described herein, the one or more fillers comprises milled carbon fibers having a carbon content greater than about 90%, or greater than about 93%, or between about 92 wt % and about 94 wt %.

In at least one embodiment described herein, the one or more fillers comprises milled carbon fibers.

In at least one embodiment described herein, the milled fibers may be substantially stable in both a downhole environment (i.e. an environment below the surface of the land and/or water in an oil and gas extraction process) as well as in subsea umbilicals, risers and flowlines, and have chemical resistance to acidic or basic conditions along with aqueous solvents and/or organic solvents. Further, for use in the downhole environment, the milled fibers may be milled polymeric fibers and may offer have excellent mechanical strength and high temperature stability. For example, the milled polymeric fibers may have a softening temperature in the range of about 250° F. to about 300° F. (about 120° C. to about 150° C.) and a melting temperature of at least about 350° F. (about 175° C.).

In at least one embodiment described herein, the one or more fillers comprises anisotropic particles (e.g. fibers) and has a length:diameter ratio greater than about 1.

In at least one embodiment described herein, the one or more fillers comprises one or more spherical particles.

In at least one embodiment described herein, the one or more fillers comprises one or more anisotropic particles with a length less than about 1 mm, or less than about 650 μm, or less than about 200 μm, or less than about 100 μm.

In at least one embodiment described herein, the one or more fillers comprises one or more anisotropic particles with a length greater than about 1 μm, or greater than about 5 μm, or greater than about 25 μm.

In at least one embodiment described herein, the one or more fillers comprises one or more anisotropic particles with a length in a range of about 25 μm to about 100 μm, or in a range of about 80 μm to about 100 μm.

In at least one embodiment described herein, the one or more fillers comprises milled carbon fibers having a diameter in a range of about 5 μm to about 15 μm.

In at least one embodiment described herein, the one or more fillers is milled carbon fibers having a diameter of about 7 μm.

In at least one embodiment described herein, the one or more fillers are present in the composite material in an amount between about 5 wt % and about 25 wt % of the weight of the polymer matrix in the composite material, or in an amount between about 5 wt % and about 10 wt % of the weight of the polymer matrix in the composite material.

In at least one embodiment described herein, the one or more fillers are present in the composite material in an amount between about 5 wt % and about 25 wt % of the weight of the composite material, or in an amount between about 5 wt % and about 10 wt % of the weight of the composite material, or in an amount of about 5 wt % of the weight of the composite material.

### EXAMPLES

In a first example, in a first step, two unidirectional tapes were manufactured using a slurry process, such as the slurry process described in U.S. Pat. No. 4,680,224. Both tapes were produced at 223 gsm. The compositions of these tapes are shown in Table 1, below. The carbon fiber was sized standard modulus fiber (33 ksi) continuous roving of 12,000 fibers. The PVDF matrix was an emulsion polymerized homopolymer with a melt viscosity of 4.0 to 8.0 kpoise when measured at 232 C and 100 reciprocal seconds using ASTM 3222. The milled carbon fiber was an unsized carbon with a length distribution between 20 microns and 600 microns—and an average fiber length of 83 microns.

TABLE 1
Compositions of the Tapes

| Tape A (control) | Tape B (example) |
|---|---|
| 50 wt % Carbon fiber | 50 wt % Carbon Fiber |
| 50 wt % PVDF matrix | 45 wt % PVDF matrix |
| | 5 wt % milled carbon fiber |

In a second step, several tapes were laid up in specific orientation and panels were consolidated using heating press for mechanical testing. Tensile properties were measured in the 0° direction on [0]₈ panels following ASTM D 3039. Compression properties were measured in the 0° direction using [(0/90)6]s panels following ASTM D 6641 and multiplying the obtained results by 2.

TABLE 2
Tensile strength and compression strength of tapes

| | Tape A (control) | Tape B (example) |
|---|---|---|
| Tensile strength 0° | 2200 MPa | 2175 MPa (−1.0%) |
| Compression strength 0° | 890 MPa | 965 MPa (+8.4%) |

As shown by the results of Table 2, compression strength of the tape increased significantly with the addition of milled carbon fiber (about 8.4% increase), while the tensile strength remained stable (about 1.0% decrease). This was surprising since the continuous fiber loading is lower in Tape B (example) vs Tape A (Control).

In another example, a different base carbon fiber was used (having a slight increase in tensile properties from Tape A to Tape C, and a slight decrease in compression properties). A milled fiber having a weight percentage higher than the milled fiber of the tapes of Table 1 was also used. The tapes had the following com positions.

TABLE 3
Compositions of the Tapes

| Tape C (control) | Tape D (example) |
|---|---|
| 50 wt % Carbon fiber | 50 wt % Carbon Fiber |
| 50 wt % PVDF matrix | 42 wt % PVDF matrix |
| | 8 wt % milled carbon fiber |

The tapes of Table 3 were tested in the same manner as described above for the tapes of Table 1. The results are provided below in Table 4.

TABLE 4
Tensile strength and compression strength of tapes

| | Tape C (control) | Tape D (example) |
|---|---|---|
| Tensile strength 0° | 2450 MPa | 2200 MPa (−10.0%) |
| Compression strength 0° | 850 MPa | 1025 MPa (+20.4%) |

These results show that the loading amount of milled fiber has a significant and surprising difference in the compression strength of Tape D with only a minor drop in tensile strength of the tape. The compression strength seems to be influenced by the loading amount of the milled fiber. The embodiments described herein therefore provide for one to fine-tune the combination compressive strength while balancing the tensile strength as well.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

What is claimed is:

1. A composite material comprising:
a polymer matrix comprising at least one homo- or copolymer;
continuous fibers dispersed within the polymer matrix, the continuous fibers being present within the composite material in an amount between about 10 wt % and about 90 wt % of a weight of the composite material; and
a filler dispersed within the polymer matrix, the filler being present within the composite material in an amount between about 5 wt % and about 25 wt % of an amount of the polymer matrix.

2. The composite material of claim 1, wherein the fillers are milled fibers.

3. The composite material of claim 1, wherein the fillers are milled carbon fibers.

4. The composite material of claim 3, wherein the milled carbon fibers have a length less than about 1 mm.

5. The composite material of claim 4, wherein the milled carbon fibers have a length less than about 150 μm.

6. The composite material of claim 5, wherein the milled carbon fibers have a length in a range of about in a range of about 25 μm to about 100 μm.

7. The composite material of claim 6, wherein the milled carbon fibers have a length in a range of about 80 μm to about 100 μm.

8. The composite material of claim 3, wherein the milled carbon fibers have a diameter in a range of about 5 μm to about 15 μm.

9. The composite material of claim 8, wherein the milled carbon fibers have a diameter of about 7 μm.

10. The composite material of claim 3, wherein the milled carbon fibers have a carbon content between about 92 wt % and about 94 wt %.

11. The composite material of claim 1, wherein the filler is present within the composite material in an amount between about 3 wt % and about 10 wt % of the weight of the composite material.

12. The composite material of claim 1, wherein the continuous fibers are present within the composite material in an amount between about 25 wt % and about 75 wt % of the weight of the composite material.

13. The composite material of claim 12, wherein the continuous fibers are present within the composite material in an amount between about 40 wt % and about 60 wt % of the weight of the composite material.

14. The composite material of claim 1, wherein the continuous fibers are unidirectional.

15. The composite material of claim 1, wherein the composite material is formed into a thermoplastic tape.

16. The composite material of claim 1, wherein the polymer matrix comprises at least one fluorinated homo- or copolymer.

17. The composite material of claim 1, wherein the polymer matrix comprises a PVDF homopolymer or copolymer that may optionally contain a portion that comprises PVDF grafted with or copolymerized with a polar carboxylic function monomer.

18. The composite material of claim 1, wherein the polymer matrix comprises ethylene tetrafluoroethylene (ETFE) or ethylene chlorotrifluoroethylene (ECTFE).

19. A multilayer structure comprising a layer comprising the composite material of claim 1.

20. The multilayer structure of claim 19, wherein the multilayer structure is a multilayer pipe.
